(19) United States
(12) Patent Application Publication
(10) Pub. No.: US 2007/0131806 A1
(43) Pub. Date: Jun. 14, 2007

(54) TIRE ASSEMBLY SUPPORT FRAME FOR IRRIGATION SYSTEMS

(76) Inventor: Don Starr, Summerville, OR (US)

Correspondence Address: GANZ LAW, P.C., P O BOX 2200, HILLSBORO, OR, 97123, US

(21) Appl. No.: 11/674,943

(22) Filed: Feb. 14, 2007

Related U.S. Application Data
(63) Continuation-in-part of application No. 10/775,669, filed on Feb. 9, 2004.
(60) Provisional application No. 60/446,057, filed on Feb. 7, 2003.

(51) Int. Cl. B05B 3/18

(52) U.S. Cl. 239/723

(57) ABSTRACT

A wheel assembly for a mobile irrigation system having an elongate boom and a plurality of downwardly extending towers. Each tower connects to a wheel assembly which may include at least one support frame for supporting a tire assembly on opposite sides of the wheels so as to distribute weight from the tower across the tire assembly. The wheel assembly may be adapted to be coupled to a tower. The wheel assembly also includes drive axle which may be rotatably coupled to the tire assembly; and a gear box which may be rotatably coupled to the drive axle and mounted on the axle in such a position that it does not support weight of the tower.

This application is a Continuation-in-Part and claims priority to and the benefit of U.S. patent application Ser. No. 10/775,669, filed Feb. 9, 2004, entitled TIRE ASSEMBLY SUPPORT FRAME FOR IRRIGATION SYSTEMS, which claims priority to and the benefit of U.S. provisional patent application No. 60/446,057, filed Feb. 7, 2003, the entire disclosure of which is hereby incorporated by reference as if set forth in its entirety for all purposes.

### TECHNICAL FIELD

This invention relates to irrigation systems and in particular to a support frame for a tire assembly for mobile irrigation structures.

### BACKGROUND OF THE INVENTION

Irrigation systems are commonly used in agricultural operations such as, for example, large scale commercial farms. One common type of such a system is a center-pivot irrigation system which typically employs an elongate boom that is connected at one end to a center pivot which acts as a water source for the boom. Typically, the boom is comprised of a plurality of pipes connected together extending away from the center pivot with sprinklers or other watering devices located along the length of the boom to spray water across the soil. The boom is elevated and supported by a number of mobile towers with wheels for transport across the ground. One of the towers acts as a drive tower so that the boom travels in wide circles about the center pivot. Some of the center pivot systems employ a corner sweep unit for systems that are located near the corner of a plot of land. The corner sweep unit is located at the end of the boom opposite the center pivot. The corner sweep unit pivots about its own axis as the corner sweep unit approaches the corner of the property as the boom rotates. Comer sweep units maximize the use of irrigation water in tight corners to ensure irrigation of the most amount of soil.

Another common type of irrigation equipment is known as a linear system that typically uses the same type of equipment described above but that travels along a straight path instead of a circular path.

The irrigation systems described above are typically repeatedly driven along their paths for a period of time to adequately irrigate the land and create very wet soil conditions over which the irrigation equipment must necessarily travel. Most current irrigation equipment systems employ tires that have a tread such as, for example, a tractor tread tire on the towers to move the system across the ground. One problem with such tires is that the tread in the tires directs water to the center of the path along which the tire travels causing further saturation of the soil creating a very muddy and soggy travel path. Because the irrigation systems are driven over the same path for long periods of time ruts eventually develop along the path. The weight of the irrigation equipment along with the soggy soil along the travel path contributes to the formation of ruts. Depending on the type of soil and how long the irrigation system travels over the same path the ruts can become several feet deep. As an example, ruts as deep as five or six feet deep are known to have been formed.

These ruts cause several problems. One problem is that the tires of the tower may become stuck so that the tower is unable to continue along the path. With very deep ruts, parts of the tower itself may engage the ground and may become stuck. For example, the towers form a frame that supports the boom and the tires. The frame may include cross struts that extend between front and back members of the frame located several feet above the ground surface. Some ruts are so deep that the cross struts are at ground level and drag along the ground surface and may become stuck. Parts of the irrigation equipment may experience damage or failure. Furthermore, a tractor or other large vehicle must be utilized to pull the tower from its stuck position. This increases the time and expense of irrigation.

Another problem caused by ruts is that they can damage other agricultural vehicles that travel across the field. For example, some commercial farm vehicles such as fertilizers typically travel across a crop field at a speed of about 15 mph. Some of these vehicles use a boom of between 80-100 ft. long to disperse fertilizer across the crop field. Other vehicles or equipment such as hay balers and harvesters carry heavy loads. Traveling across ruts at such speeds puts great stress on the vehicles and they may experience damage. Significant damage may occur with very deep ruts. In order to avoid damage the vehicles must slow down each time a rut is encountered. Since the vehicles are unable to travel at a constant speed production time and labor costs are increased.

Yet another problem caused by ruts is erosion. Erosion is a problem encountered with many agricultural endeavors. Ruts magnify the erosion problem by providing a channel in which the irrigation water or rain water washes away topsoil. This is especially problematic on land that slopes or on farmed land located on hillsides. In some instances the washed-away soil may be recovered and hauled back to its original location. If the washed-away soil is not recoverable new soil must then be brought in and distributed over the eroded land. In addition to damage to the land such erosion causes increased expense for soil recovery and/or replacement.

Some attempts to solve the problem with ruts include filling the ruts with straw, wood chips, compost, gravel, concrete or debris. This attempt has not proved to be acceptable because of land pollution and contamination issues. Successive land owners may experience damage to some equipment and may be required at great expense to clean up and remove the fill material. If contamination of the soil is an issue additional costs must be incurred to remove such contaminants.

Other attempts to fill the ruts include the use of commercially available clotting pellets or other clumping material that hardens when wet. However, such products have proved to be inconsistently effective. Additionally, these products must be purchased every time a rut is formed which increases costs and requires continued maintenance.

One prior art device that attempts to prevent formation of ruts utilizes a ground engaging track for the tower wheels. The track comprises flat plates or sections that are hinged together around the tire. The device has side walls that extend down the sides of the tire. The problem with such a device is that the hinges wear out which may cause damage and require repair or replacement of the device. The side walls of the device also pinch the sides of the tires causing wear and damage to the tires. Additionally, if the device encounters a rocky patch in the soil the device may get stuck or stall causing the tire to spin inside the track. Furthermore, such a device experiences vibration which loosens lug nuts on wheels and causes noise.

Other attempts to prevent ruts from forming include the use of steel wheels. However, such wheels are very heavy and place a great deal of stress on the axle and/or gear box of the tower drive mechanism. Additionally, such steel wheels require a vehicle such as, for example, a front end loader to attach the steel wheel to the tower.

Accordingly, there is a substantial need for mobile irrigation systems that provide for better weight distribution over the wheel so as to help minimize the formation of ruts and more freely move across a field.

There is also a need for improved wheel support systems that more efficiently distribute weight and also allow for mounting of a gearbox to a tower and wheel assembly in a manner whereby the gearbox does not bear the tower's weight, which can lead to damage of the gearbox.

### SUMMARY OF THE INVENTION

The inventive subject matter overcomes problems in the prior art by providing a tire assembly support frame for irrigation systems with the following qualities, alone or in combination. Certain possible embodiments that illustrate the inventive subject matter are as follows.

A mobile irrigation system includes an elongate boom and a plurality of downwardly extending towers, each connecting to a wheel assembly. In an example embodiment, the wheel assembly may have at least one support frame for supporting a tire assembly on opposite sides so as to distribute weight from the tower across the opposite sides of the tire assembly and the wheel assembly is adapted to be coupled to a tower. The wheel assembly further may have at least one drive axle rotatably coupled to the tire assembly; and a gear box rotatably coupled to the drive axle and mounted on the axle in such a position that it does not support weight of the tower. The gear box may be mounted outside the support frame.

In one possible embodiment, the tire assembly includes dual wheels. In another embodiment, the tire assembly may include at least one wheel having a belt with traction elements. In yet another embodiment, the support frame provides for an adjustable connection between the tower and the tire assembly. Such an adjustable connection may, for example, be provided by at least one slotted plate, at least one spring, by telescoping members, or by a pillow block bearing.

In another possible embodiment, the wheel assembly may include a swivel support tube that is telescopically coupled to a tube of the tower allowing the wheel assembly to swivel around the tower.

In certain embodiments, the support frame may have a first support member for supporting a tire assembly on one side; a second support member for supporting the tire assembly on the opposite side and coupled to the first support member, such that the weight of the tower is distributed substantially equally across the opposite sides of the tire assembly. In one embodiment, the first support member may be connected to the second support member creating a support frame having a substantially U-shape. In another embodiment, the first support member may be adjustably coupled to the second support member. In yet another embodiment, a gear box may be mounted outside of the support frame.

In another embodiment, a force transfer member is coupled between the support member and the tower for transferring forces generated by the tire assembly to the tower. Optionally, the force transfer member may provide for an adjustable connection to the tower.

In certain embodiments, a wheel assembly may have a support frame having a first support member for supporting a tire assembly on one side; a second support member for supporting the tire assembly on the opposite side and adjustably coupled to the first support member, such that the weight of the tower is distributed substantially equally across the opposite sides of the tire assembly; at least one drive axle rotatably coupled to the tire assembly; and a gear box being rotatably coupled to the drive axle and mounted on the axle in such a position that it does not support weight of the tower. In this embodiment, the gear box may also be mounted outside of the support frame and optionally a support frame may be adjustably mounted on the tire assembly.

The present invention, in certain respects, provides a device for irrigation systems that prevents the formation of ruts caused by repeated travel along a path by tires of a mobile vehicle or structure. The irrigation system includes an elongate boom connected at one end to a center pivot that acts as a water source for the boom. The boom includes a plurality of pipes connected together to extend away from the center pivot with sprinklers located along the length of the boom to spray water across the soil. The boom is elevated and supported by a number of mobile towers each of which has a tire assembly for transporting the tower and, thus, the boom across the ground in wide circles about the center pivot.

Each tire assembly includes one or more tires mounted on an axle with an optional flexible member wrapped around the outer periphery of the two tires, such as a flexible belt. The flexible belt member may be adapted to be wrapped around the dual tires so that an inner surface of the flexible belt member engages the outer periphery of the tires and an outer surface of the flexible belt member engages the ground. The flexible belt member includes opposed ends and means to secure the opposed ends together when mounted on the dual tires.

The flexible belt member may include a plurality of spaced apart traction elements or cleats located on the outer surface of the flexible belt member. The traction elements provide traction as the tower moves along the path. The traction elements may be spaced apart a distance to allow the flexible belt member to engage the ground and provide a ground engaging surface to substantially evenly distribute the weight of the tower structure across the ground to reduce ground compaction. Furthermore, the traction elements direct water away from the center of the travel path to the outer sides thereof.

According to the inventive subject matter, a center pivot may have a dual tire assembly in which one tire is inflated to inflation pressure that is greater than that of the other tire. Inflating one tire to a pressure greater than the other tire prevents too much pressure or leverage from being applied to the tire assembly drive mechanism. The inner tire or tire located toward the center pivot may be inflated to about twice the pressure of the outside tire.

The invention may further provide a tire assembly support frame that supports the tire assembly. The support frame substantially removes forces carried by the outer tire that would otherwise be transferred to the gear box possibly causing damage. The support frame may be connected to and supported by the tower structure on one side and is connected to the outer tire through an extended axle. The support frame includes a force transfer member connected between the support frame and the tower structure for transferring forces generated by the tire assembly to the tower structure. The support frame includes a plurality of adjustable mounting features to accommodate retrofitting to a variety of existing units. One or more compensating springs may be incorporated into the support frame to adjust to varying pressure applied to the support frame by uneven terrain. The support frame, including at least the features mentioned above, may also be adapted for use with corner sweep units.

The invention is particularly effective in wet or loose soil environments created by irrigation systems and/or farming activities for large or commercial farms. Although the invention is described as being used primarily with center pivot irrigation systems, it is contemplated that the present invention not be limited to center pivot irrigation systems but may also be used with other irrigation systems such as, for example, linear irrigation systems and other mobile structures in which the formation of ruts in the ground is a problem.

These and other embodiments are described in more detail in the following detailed descriptions and the figures.

The foregoing is not intended to be an exhaustive list of embodiments and features of the present inventive concept. Persons skilled in the art are capable of appreciating other embodiments and features from the following detailed description in conjunction with the drawings.

### BRIEF DESCRIPTION OF THE DRAWINGS

FIG. 1 is a top plan view of a simplified center pivot irrigation system utilizing mobile support structures to support an elevated boom, according to the prior art.

FIG. 2 is a partial front view of a mobile support structure with a tire assembly, according to the prior art.

FIG. 3 is a front view of the tire assembly according to the prior art.

FIG. 4 is a side view of the tire assembly according to the prior art.

FIG. 5 is a side view of the flexible belt in a flat condition according to the prior art.

FIG. 6 is a sectional view along lines 6-6 in FIG. 7 of a support frame for the tire assembly according to the inventive subject matter disclosed herein.

FIG. 7 is a front view of a support frame for a tire assembly of a center irrigation unit according to the inventive subject matter disclosed herein and wherein the tire assembly is shown in phantom.

FIG. 8 is a side view of the support frame with the tire assembly and flexible belt according to the inventive subject matter disclosed herein.

FIG. 9 is an enlarged partial front view of the mounting of the support frame to the tower structure.

FIG. 10 is a side view of the mounting shown in FIG. 9.

FIG. 11 is a front view of a support frame for a corner unit of an irrigation system according to the inventive subject matter disclosed herein.

FIG. 12 is a side view of the support frame as shown in FIG. 11.

FIG. 13 is a partial view showing the connection between the support assembly and the horizontal members of FIGS. 11 and 12.

FIG. 14 is a front view showing another embodiment of the corner sweeping unit support frame according to the inventive subject matter disclosed herein.

FIG. 15 is a partial view showing the connection between the support assembly and the horizontal members of FIG. 14.

FIG. 16 is a front view of a wheel assembly for a corner sweeping unit of an irrigation system according to the inventive subject matter disclosed herein.

FIG. 17 is a perspective view of the different parts of a spindle drive assembly according to the prior art.

FIG. 18 is a front view of a wheel assembly for a corner unit of an irrigation system according to another embodiment of the inventive subject matter.

FIG. 19 is a perspective view of the support frame shown in FIG. 18.

FIG. 20 is a simplified side view of the support frame shown in FIG. 18.

FIG. 21 is a simplified top view of the support frame shown in FIG. 18.

FIG. 22 shows a detail of the corner unit shown in FIG. 18.

FIG. 23 shows another detail of the corner unit shown in FIG. 18.

FIG. 24 shows a top view of the towers of a center unit irrigation system and a corner irrigation system in two possible positions.

FIG. 25 shows a perspective view of a corner unit irrigation system while attached to a center unit.

### DETAILED DESCRIPTION

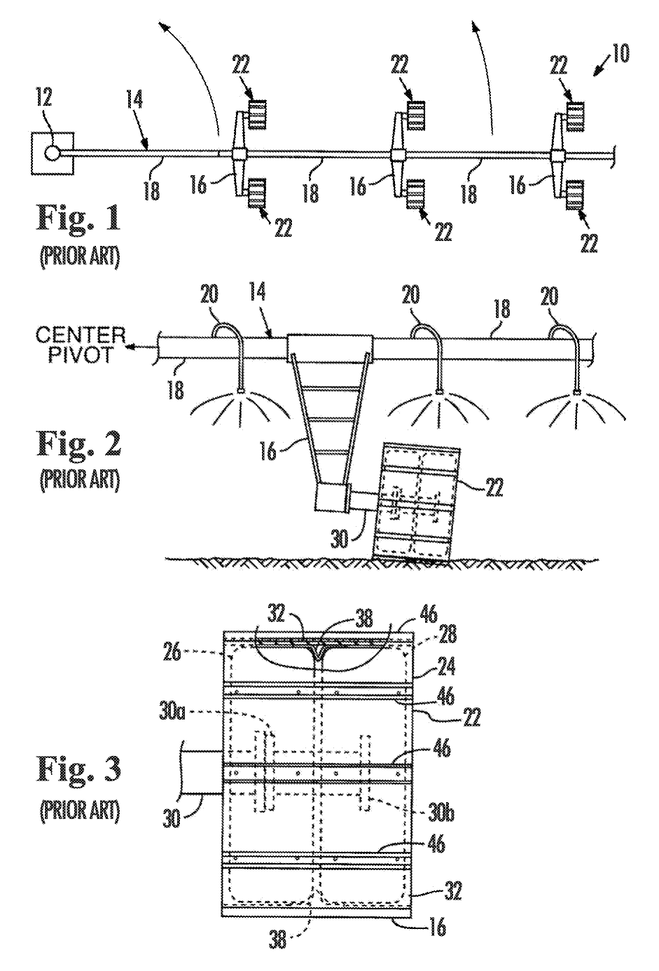

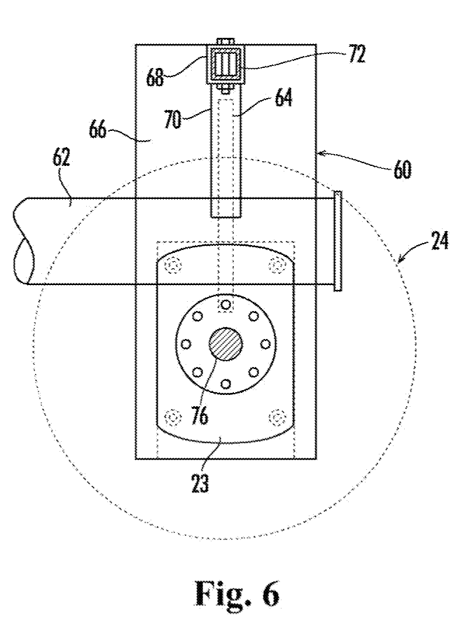

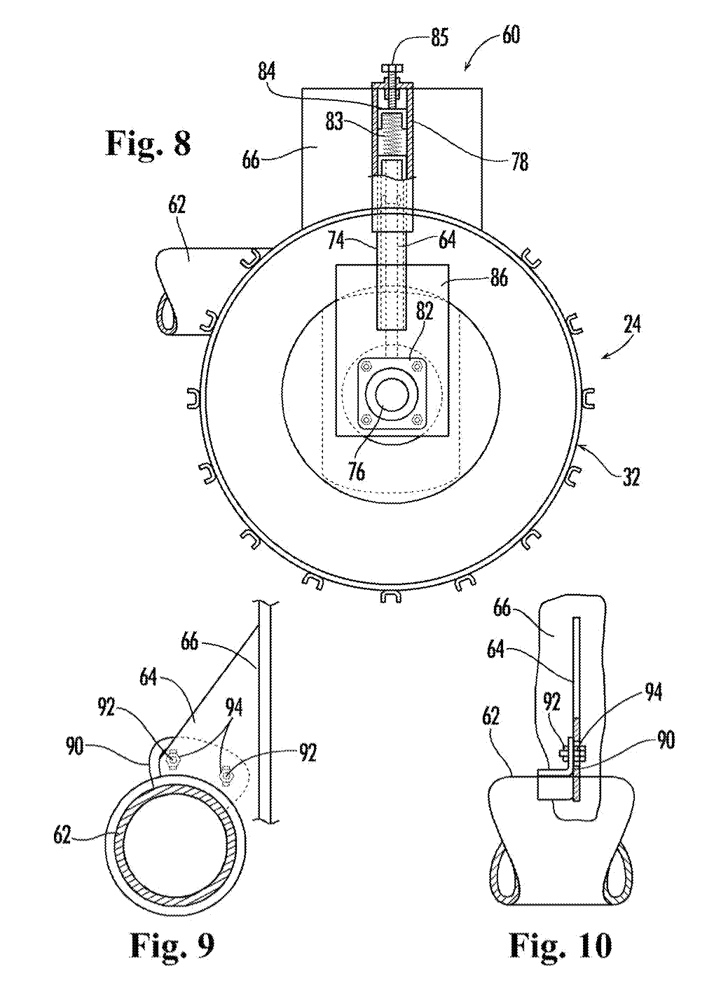

Representative embodiments of the inventive subject matter are shown in FIGS. 6-16 and 18-25, wherein similar features share common reference numerals. For comparison, FIGS. 1-5 and 17 illustrate the prior art.

Referring now to FIGS. 1 and 2, a center pivot irrigation system 10 is shown in accordance with the prior art wherein the system 10 is adapted to rotate about a center pivot 12 that serves as a water supply for an elevated boom 14. Boom 14 is supported on a plurality of mobile support structures or towers 16.

Although FIGS. 6-10 illustrate a center pivot irrigation system the inventive subject matter is not intended to be limited to center pivot irrigation systems. Additionally, although only one boom 14 and three mobile towers 16 are shown, the inventive subject matter is not intended to be limited to the number of booms or mobile tower structures. The number of towers depends of the length of the boom which is dependent on the size of the area of land to be irrigated. For example, the span between mobile towers 16 is typically between about 130 to 140 ft. However, this length may vary.

As seen in FIGS. 1 and 2, centrally located pivot structure 12 serves as a water supply to boom 14. Boom 14 comprises a plurality of pipes 18 connected end-to-end with sprinklers 20 spaced along the length of boom 14. Boom 14 is supported by mobile towers 16 that have ground engaging elements 22 to propel boom 14 along a travel path about central pivot 12. Each tower 16 includes front and rear ground engaging elements 22. Towers 16 are self-propelled by ground engaging means 22 that are driven through a gear box drive mechanism 23 in a manner known to those skilled in the art.

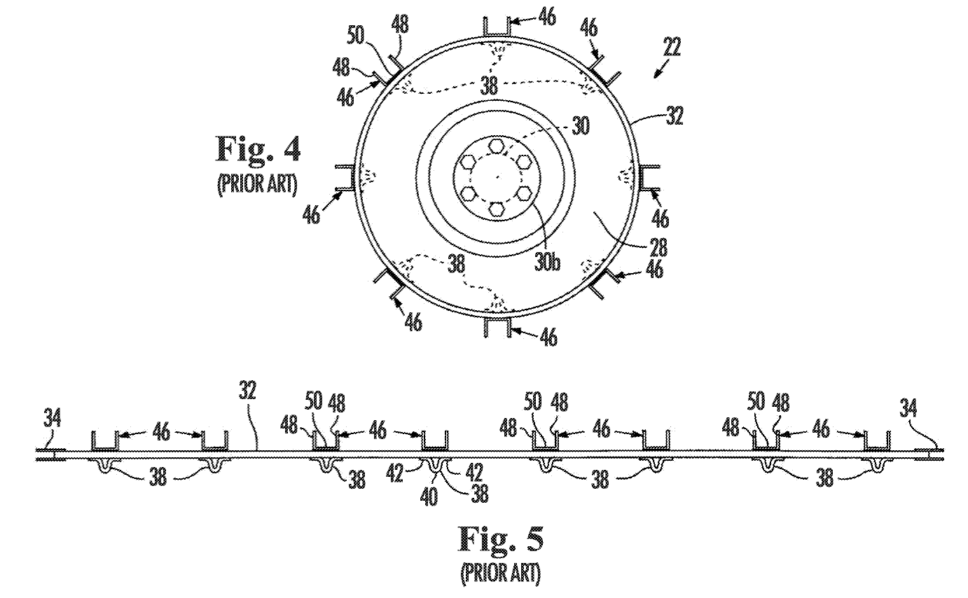

As seen more clearly in FIGS. 2-4, each ground engaging means 22 is shown as a tire assembly 24 including, for example, dual tires 26 and 28 mounted for rotation on a hub 30. Hub 30 includes flanges 30a and 30b on each end having bolt holes matching the bolt hole configuration on the wheels as best seen in FIG. 4. One of the flanges 30a is connected to a flange 29 on an axle 31 from gearbox 23 by bolts or any other suitable connection. Hub 30 acts as an extension from gearbox 23 to accommodate mounting of dual tires 26 and 28. FIG. 2 shows that tire assembly 24 is canted or mounted on an angle to a vertical axis. This is done to prevent the application of too much force or pressure on the axle 31 and/or gear box 23 as system 10 is driven around its travel path. For example, tires that are mounted normal to the boom 14 and supported on an axle positioned normal to tower 16 have the tendency to follow a straight path. However, the tires are forced from a straight path by the center pivot structure so that the tires travel in a circular path. This puts a great deal of stress on axle 31 and/or gear box 23 as well as causing wear on the tires. Tire assembly 24 is capable of having a canted mounting by inflating one of the tires to a pressure of about twice that of the other tire. For example, the tire closest to the center pivot, referred to as the inner tire as seen most clearly as tire 26 in FIG. 3, may have an inflation pressure of about 28-30 psi. The other tire, referred to as the outer tire as seen most clearly as tire 28 in FIG. 3, may have an inflation pressure of about 10-12 psi. Thus, the tires 26 and 28 counteract the force from center pivot 12 tending to pull or force tires 26 and 28 toward center pivot 12.

Tire assembly 24 includes a flexible member, such as a belt 32 or track, wrapped around the outside of tires 26 and 28. Belt 32 is made of a flexible material such as, for example, rubber and has a substantially flat shape before mounting on tires 26 and 28 as seen in FIG. 5. Belt 32 has a length and a width with opposed ends having a coupler 34 to connect the opposed ends of belt 32. One example of such a coupler 34 is belt lacing that may be interwoven and secured with the opposed ends of belt 32 when it is wrapped around tires 26 and 28. However, although only belt lacing is described as one type of coupler it is within the scope of this invention that any suitable coupler for connecting the opposed ends of belt 32 may be utilized. In order to mount belt 32 onto tires 26 and 28 they may be deflated to an inflation pressure less than that in use to facilitate mounting of belt 32 around the outer periphery of tires 26 and 28. After belt 32 is mounted on tires 26 and 28 they are inflated to their respective inflation pressures as described above. The length and width of belt 32 may vary according to the size of tires used. For example, with 14.9×24 tires, belt 32 may have a length of about 156 inches and a width of about 30 inches. As another example, for 11.2×24 tires, belt 32 may have a length of about 139 inches with a width of about 24 inches.

Belt 32 has an inner surface 36 that lies adjacent to the outer surface of tires 26 and 28 when mounted thereon. A plurality of center guides 38 are mounted to inner surface 36 of belt 32. Each center guide 38 is a formed metal piece having a central protrusion 40 with flat ends 42 for connection to inner surface 36 of belt 32 by a suitable connector, such as, for example, with a strong adhesive or a fastener pin. Center guides 38 help keep belt 32 in place during use.

Outer surface 44 of belt 32 includes a plurality of traction elements 46 that substantially extend across the width of belt 32 as best seen in FIG. 3. In this example, the traction elements are in the form of cleats that span the width of the tire assembly. Traction elements 46 may be in the form of channel iron having side walls 48 extending outwardly from a base 50. Base 50 may be secured to outer surface 44 of belt 32 by any suitable connector such as, for example, fastener pins, so that side walls 48 engage the ground to provide traction as tire assembly 24 moves along the travel path. Side walls 48 further act to direct water to the outer sides of tire assembly 24 and, thus, away from the center of the travel path. Traction elements 46 are spaced along the length of belt 32 in a manner to allow outer surface 44 to engage the ground. In one example, traction elements 46 are spaced about 10 inches apart. Although traction elements 46 are described as channel iron, other types of traction elements may be envisioned by the inventive subject matter for channeling water away from the center of the travel path, as well as for traction. In addition to traction elements, any other means for creating traction may be used, including various patterns that increase surface area, such as cleats, treads, grooves, channels, knobs, paddles, etc.

Tire assembly 24, as illustrated by the prior art reduces soil compaction by providing a ground engaging surface area 44 of belt 32 to distribute the weight of the irrigation equipment. As one example, some prior center pivot irrigation systems can produce a force on the ground of about 86 pounds per square inch depending on the size of the tire. Using tires of comparable size, tire assembly 24 produces a force of only about 26 pounds per square inch on the ground. Thus, the reduction of soil compaction substantially reduces the formation of ruts in the ground. Additionally, directing water away from the center of the travel path by traction elements 46 further reduces the formation of ruts in the ground.

In general, a wheel assembly for a mobile irrigation system has an elongate boom and a plurality of downwardly extending towers, each connecting to a wheel assembly. According to the inventive subject matter, a wheel assembly includes a support frame and a tire assembly. A tire assembly is defined as having one or more wheels and an associated axle. The support frame supports the assembly on opposite sides so as to distribute weight from the tower structure across the opposite sides of the tire assembly. The opposite side of the tire assembly refers to the opposite sides of the axle that connects one or more tires. The axle may be formed as a single unit or as a multiple mechanically coupled units associated with the tires. The wheel assembly may be coupled, either permanently or removably, to a tower structure. A tire assembly may include an optional flexible member and traction elements (e.g., belt 32 and traction elements 46).

FIGS. 6-8 show a support frame 60 for tire assembly 24 according to the inventive subject matter. Support frame 60 may optionally be removably connected to and supported by horizontal tube member 62 of tower 16 by a force transfer member, such as for example a force transferring support plate 64. Support plate 64 may be welded or otherwise secured to an attachment plate 66 to which gear box 23 is secured through outer plate 65 by bolts or fasteners 67. Tire assembly 24 may be supported by horizontal support members, such as a first support member 68, a third support member 72, and a vertical or second support member 74. These support members may, in combination with springs, provide for a connection that is adjustable in both the vertical and horizontal directions between tower 16 and tire assembly 24. This adjustability feature of the support frame allows the frame to be retrofitted for a variety of irrigation systems having different tire assemblies, and a variety of field circumstances, such as compensating for unevenness in the terrain.

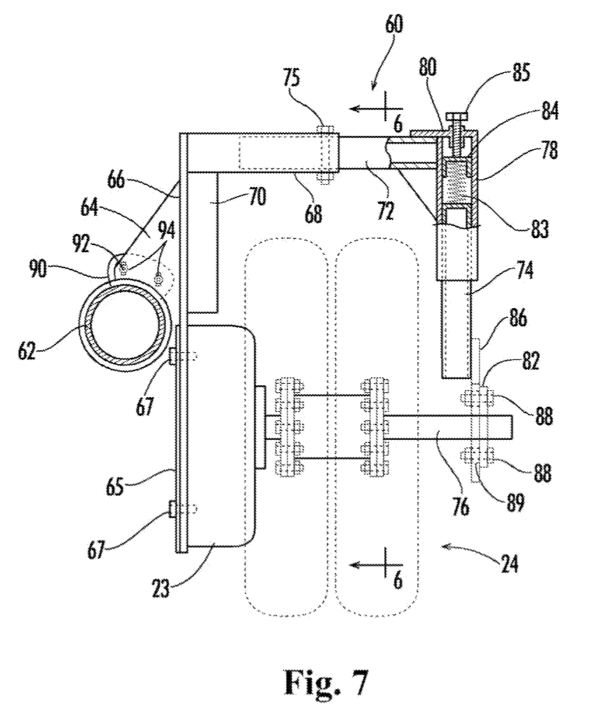

As shown in FIG. 6, the support members may create a support frame that has substantially a U-shape. Horizontal members 68 and 72 may provide for horizontal adjustment by a telescoping connection and may be secured by a bolt 75 or other suitable fastener. This telescoping connection provides for horizontal adjustment of support frame 60 to accommodate various sizes of tires. In the embodiment shown in FIG. 7, member 68 telescopically receives member 72 and may be welded or otherwise secured substantially centrally to attachment plate 66. A strengthening element 70 may be welded or otherwise secured to both attachment plate 66 and member 68 to add support for member 68 and strength to plate 66. Vertical support 74 extends down from third member 72 and may be connected thereto through an adjustable telescoping connection. Vertical support 74 may be telescopically received within a tube member 78 connected to member 72 through a plate 80 that may be welded or otherwise secured thereto. Strengthening gussets 81 may be welded or otherwise fastened to secure tube member 78 and plate 80 to member 72. In order to provide further adjustment, a spring 83 extends between vertical support 74 and a bearing plate 84. An adjustment member such as, for example, a bolt 85 extends through a plate 80 and bears against bearing plate 84 to adjust the amount of force or pressure applied to the ground. Spring 83 provides that pressure is carried as evenly as possible on both sides of support frame 60. For example, on flat terrain pressure is distributed substantially evenly across support frame 60. However, if the terrain is uneven and is pitched higher on one side the pressure applied to that side of support frame is increased. Therefore, spring 83 substantially compensates for unevenness in the terrain and can be adjusted to match the terrain across which tire assembly 24 travels. Vertical support 74 supports an extended axle 76 of tire assembly 24 through plate 86. Plate 86 may be welded or otherwise secured to vertical support 74. A bearing 82 rotatably supports extended axle 76 and may be adjustably connected to plate 86 by bolts 88 or other suitable connectors extending through elongated bolt holes 89 in plate 86. This adjustability feature allows support frame 60 to be retrofit to a variety of tire assemblies 24. For simplicity, FIGS. 6 and 7 do not show belt 32 on tire assembly 24. However, it is understood that belt 32 may be used with tire assembly 24 in all embodiments of this invention.

FIGS. 9 and 10 show a detail of a force transfer member that is adjustably mounted to the tower structure, for example with an adjustable connection between horizontal tube member 62 and support plate 64. As shown, a bracket or vertical plate 90 may be welded or otherwise secured to horizontal tube member 62. The adjustable mounting of the force transfer member to the tower structure may be provided by support plate 64, which is removably connected to bracket 90 by bolts 92 or any other suitable fasteners extending through elongated holes 94 in support plate 64. Horizontal tube members 62 may vary in diameter. Elongated holes 94 provide adjustment so that support plate 64 may be connected to horizontal tube members 62 regardless of its diameter. Thus, as can be seen in FIGS. 6- 10, support frame 60 substantially transfers forces to horizontal tube member 62 that would otherwise be applied to gear box 23 through tire assembly 24.

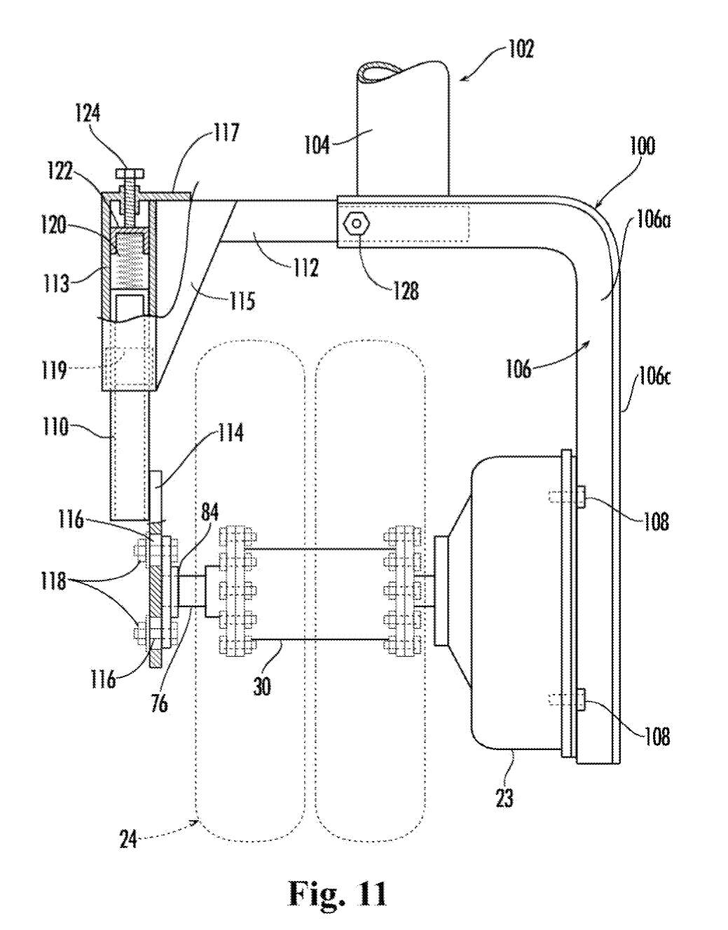

FIGS. 11-13 show another embodiment of the inventive subject matter in which a support frame 100 is utilized in a corner sweep unit 102 of an irrigation system. Comer sweep unit 102 includes tire assembly 24 with first and second tires mounted on an axle 30 and driven through gear box 23 as shown and described above. Comer sweep unit 102 may include a swivel support tube 104 that is telescopically received in a drive tube (not shown) so that corner sweep unit 102 rotates or is driven about swivel support tube 104 as is known in the art. Swivel support tube 104 may be connected to a frame assembly 106 that supports gear box 23 through bolts 108 or other suitable fastener. Frame assembly 106 may include opposed members 106a and 106b secured together by welding to a connector plate 106c as seen most clearly in FIG. 13. For clarity, swivel support tube 104 has been omitted from FIG. 13. Tire assembly 24 is supported on opposite sides by a first support member, such as vertical member 110, and an associated second support member, such as horizontal member 112. Tire assembly 24 may be connected to vertical member 110 through extended axle 76 rotatably supported by bearing 84. The support frame 100 adjustably supports the tires assembly 24 both horizontally and vertically. Bearing 84 may be adjustably connected to vertical member 110 through a plate 114 that extends between and may be welded or otherwise secured to vertical member 110. Plate 114 includes elongated holes 116 through which bolts 118 or other fasteners extend. This adjustability feature allows support frame 100 to be adjustable in a horizontal direction and thus retrofit to a variety of tire assemblies. Vertical adjustment may be provided by vertical members 110 which may be connected to horizontal members 112 in a manner similar to that as shown and described in FIG. 7. More specifically, each vertical member 110 may be telescopically received in a female member 113 secured to a horizontal member 112 and strengthened by a gusset 115.

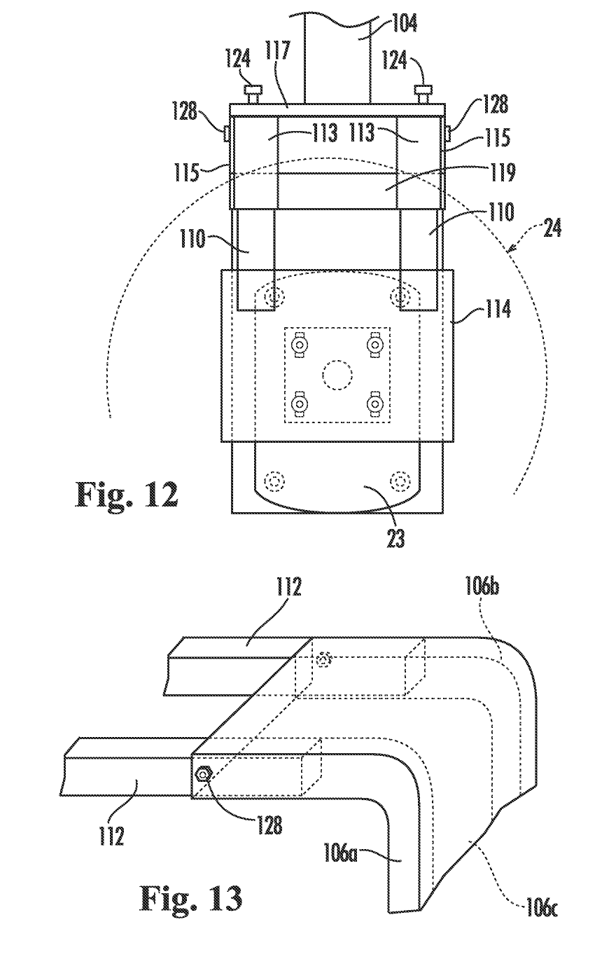

Additional adjustability in the horizontal direction may be provided by a spring 120 which may extend between vertical support 110 and a bearing plate 122. An adjustment member such as, for example, a bolt 124 may extend through plate 117 to bear against bearing plate 122 to adjust the amount of force or pressure applied to the ground. As described above, spring 120 provides that pressure is carried as evenly as possible on both sides of support frame 100 as the corner sweep unit 102 travels over uneven terrain. To strengthen and support vertical members 110, plate 117 extends between opposed vertical members 110 and opposed horizontal members 112 and may be welded or otherwise secured to vertical members 110 and horizontal members 112 as most clearly seen in FIG. 12. Additionally, a further strengthening member 119 is secured such as, for example, by welding between vertical members 110. Horizontal members 112 may be telescopically received in members 106a and 106b of frame assembly 106 and secured thereto by any suitable type of fastener 128. This telescopic connection allows for adjustment to accommodate tire assemblies of different widths.

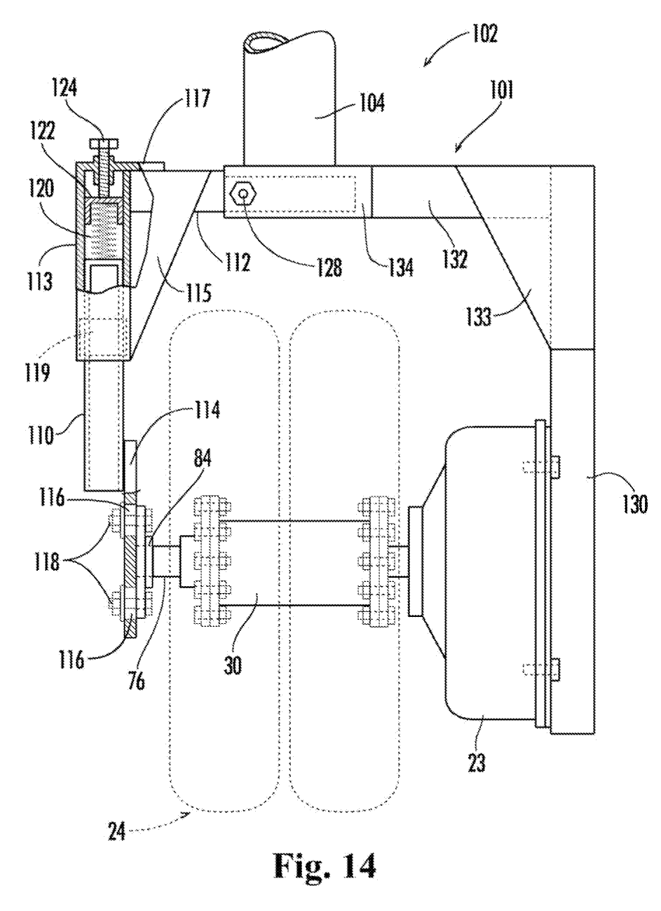

FIGS. 14 and 15 show an alternative support frame 101 in which gear box 23 is supported by a vertical member 130 and a horizontal member 132 welded or otherwise secured thereto and strengthened by at least one gusset 133. In this embodiment, horizontal members 112 may be telescopically received in opposed female members 134 that have been welded or otherwise secured to each side to horizontal member 132 as best seen in FIG. 15. For simplicity, swivel support tube 104 has been omitted from FIG. 15. Horizontal members 112 may be secured to associated members 134 by any suitable type of fastener 128. This telescopic connection allows for adjustment to accommodate tire assemblies of different widths. For simplicity, FIGS. 11-13 are shown with belt 32. However, it is understood that any belt may be used with the tire assembly in these embodiments.

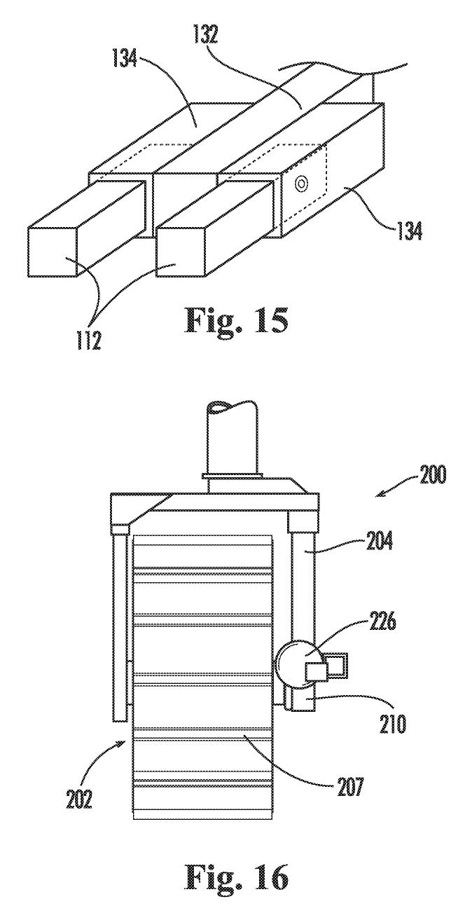

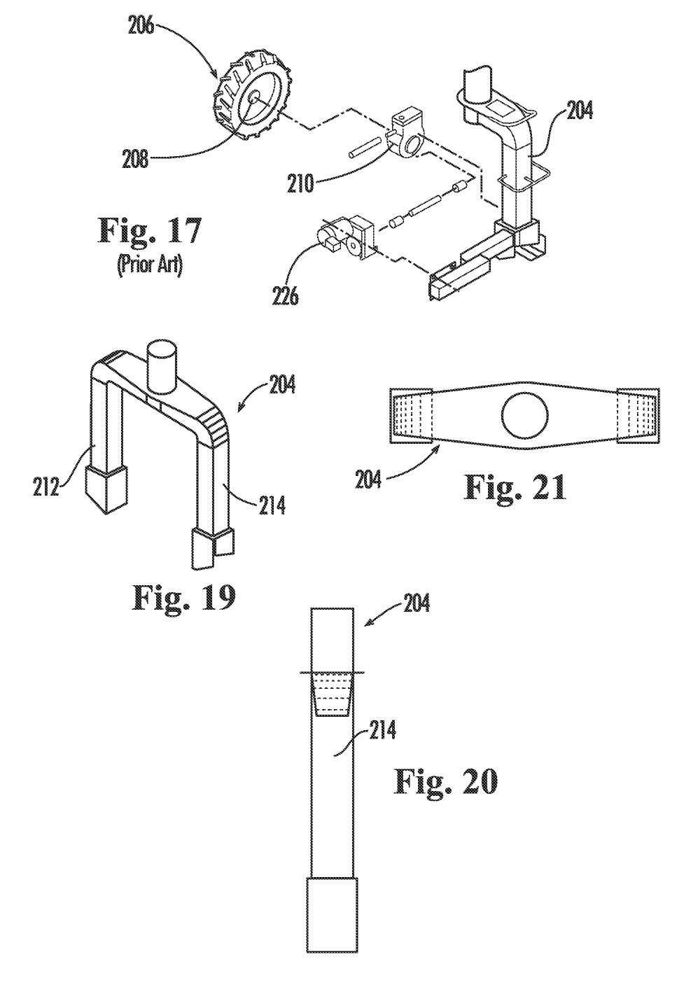

Another example embodiment of the inventive subject matter is illustrated by FIGS. 16 and 18-25. For comparison, a prior art assembly is illustrated by FIG. 17.

As described above, the mobile irrigation system may have an elongated boom and downwardly extending towers, each connected to a wheel assembly. Although FIGS. 16-25 depict the wheel assembly for a corner sweeping unit, the wheel assembly is not intended to be limited to a corner sweeping unit and may be adapted to be used on any other irrigation system, such as a center pivot system or lateral moving irrigation system.

The tower of the irrigation system may be conventional and usually includes a main frame in the form of a tube or pipe attached to a water distribution pipe. The wheel assembly may be either permanently or removably coupled to the towers. A removable coupling may be accomplished via a swivel support tube on the tower, which is telescopically received by a tube of the support frame of the wheel assembly allowing the wheel assembly to swivel around the tower.

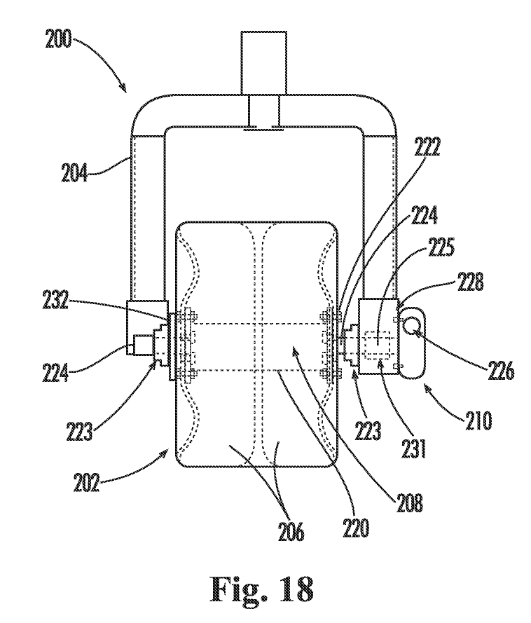

FIGS. 16 and 18 show a wheel assembly 200 having a tire assembly 202 and a support frame 204. Tire assembly 202 may have one or more wheels 206 and an associated drive axle 208. The wheels 206 typically include a hub and an inflatable tire covering the hub. However, a wheel need not be based on a rubber tire. The hub and tires may be made of any suitable material. Axle 208 may be coupled to support frame 204 by various methods that are known in the art. Axle 208 may be formed of a single unit or multiple mechanically coupled units associated with the wheels. For example, as shown in FIG. 18, axle 208 may have an extension hub 220 in the center of the tire assembly and stub shafts 224 at both ends of the tire assembly. Extension hub 220 and stub shafts 224 may be bolted together through the respective end flanges 222. Bearings 223 may separate the moving parts and provide additional compliance and strength to the axle. The dimensions and the number of mechanically coupled units of an axle is adjustable depending on the size of the wheels and tires. For smaller wheels, additional strength of the stub shafts may be provided by mounting sleeves with support gussets on the stub shafts.

The tire assembly may have any number of individual wheels provided with either conventional tires or tires having traction elements, or any combination thereof. Any number of tires may be covered with a flexible member, such as a belt disclosed in the inventor's prior U.S. Pat. No. 6,616,374. As shown in FIGS. 16 and 18, the corner sweeping unit has a tire assembly with dual wheels 206 covered with a belt and traction elements 207.

FIG. 17 illustrates a wheel assembly for a corner unit irrigation system according to the prior art, having a gear box 210 in a standard position, i.e. mounted on an axle 208 and positioned on the inside of support frame 204; thereby, connecting wheel 206 with support frame 204. In this position, the weight of the tower exercises stress on the gear box 210, which often leads to associated problems such as axle breakage.

A solution for this problem is illustrated in FIGS. 16 and 18-25, wherein gear box 210 is mounted outside of support frame 204, so that the gear box mechanism is not subject to weight of the tower and the associated stress this causes. As seen in FIG. 18, the outside of the support frame refers to the side of the frame opposite to the tire assembly.

Support frame 204 attaches to tire assembly 202 on opposite sides of the wheels 206, so as to distribute weight of the tower across the opposite sides of the tire assembly. The wheel assembly also includes a motor 226 and a gear box 210. A drive shaft 225, coming out of the gear box, is rotatably coupled to axle 208 of the tire assembly and drives wheels 206. The gear box may transmit drive from the drive motor to the tires through various methods as known in the art.

The support frame may be formed as a single unit or as connected support members, in either case, the vertically and horizontally oriented portions may be deemed to be “coupled”, and the term and its variants shall be construed similarly when used to describe other structural arrangements herein. Referring to FIG. 19, support frame 204 includes a first support member 212 for supporting the tire assembly on one side and a second support member 214 for supporting the tire assembly on the opposite side and coupled to the first support member 212. The support members may create a substantially U-shaped support frame or yoke, which carries the tires on opposite sides and whereby first and second support members of the frame disperse the weight of the tower substantially equally across the opposite sides of the tire assembly.

Similarly to the embodiments described above, the support frame may provide for an adjustable connection between the tower and the tire assembly. Adjustability in both horizontal and vertical directions accommodates different sizes of wheels. The adjustability may be accomplished by using springs, slotted plates, telescoping means or other associated compliance parts. For example, horizontal adjustment can be achieved through telescoping means, while vertical adjustment may be provided through slotted plates, springs, or pillow block bearings. Alternatively, the support frame may not be adjustable at all.

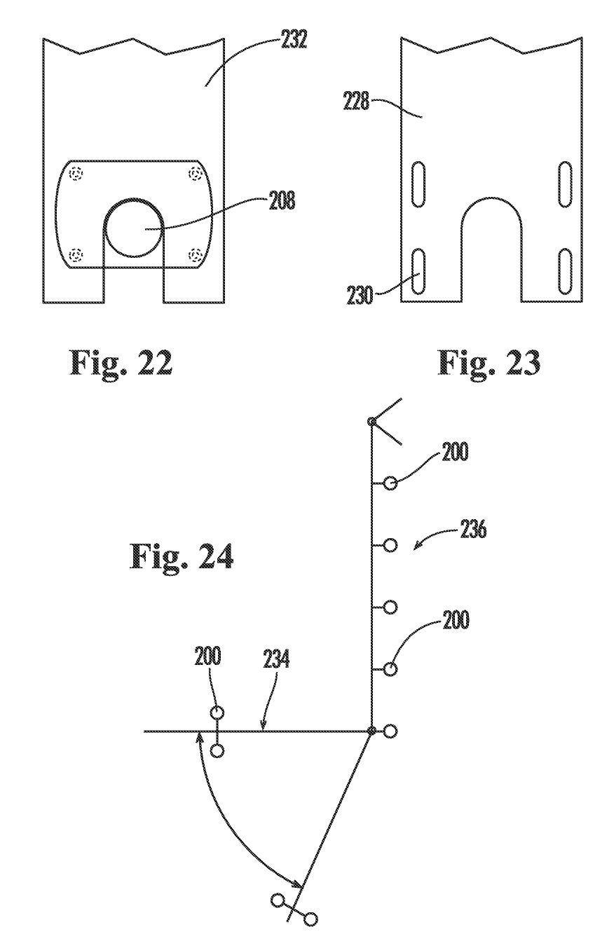

The gear box includes a housing and a drive mechanism, as is known in the art. The housing of the gear box may be mounted on the axle and bolted or otherwise suitably secured to the support frame. As shown in detail in FIG. 18 and 23, gear box 210 may, for example, be bolted on the outside of support frame, so as not to bear weight of the tower. In one possible arrangement, gear box 210 is connected to the outside of the support frame by a first slotted plate 228 adapted for mounting of the gearbox. Slotted plate 228 may have mounting holes 230 allowing for bottom insertion and axle alignment. Drive shaft 225 of the gear box may be rotatably coupled to the axle by various methods such as for example by a flexible coupler 231 or a collar connecting the drive shaft to axle 208 with set screws. On the other side of the tire assembly, axle 208 is removably connected to the support frame 204 through a second slotted plate 232, as illustrated in FIG. 22, which allows insertion of axle 208 from the bottom of the plate.

Suitable gear boxes and motors are available through known providers, such as DURST, a Regal-Beloit Company of Shopiere, Wis. or Universal Motion Components of Costa Mesa, Calif. The motor may be either electric or hydraulic, and connected to a gear box through either direct couple, linked, or remote via a Power Take-Off shaft. In another example embodiment, the support frame may have a force transfer member coupled between the support member and the tower for transferring forces generated by the tire assembly to the tower. As described above, the force transfer member may also be adjustably mounted to the tower.

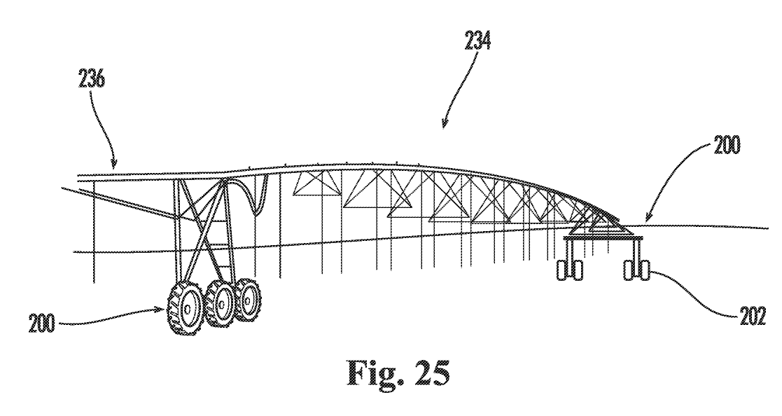

FIG. 24 shows a corner unit 234 trailing along with a center pivot unit 236. FIG. 25 illustrates how corner unit 234 swings out from a first position A into a second position B when the corner unit is activated at the corner of a field, for example. The wheel assembly disclosed herein may replace conventional assemblies of an irrigation system either at one particular location; at several locations; or at all locations along the boom, depending on the specific soil conditions of a field and the irrigation system used.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein. All patent and non-patent literature cited within this application is hereby incorporated by reference as if listed in its entirety herein.

What is claimed is:

1. A wheel assembly for a mobile irrigation system having an elongate boom and a plurality of downwardly extending towers, each connecting to a wheel assembly, a wheel assembly comprising:
at least one support frame for supporting a tire assembly on opposite sides so as to distribute weight from the tower across the opposite sides of the tire assembly and adapted to be coupled to a tower;
at least one drive axle rotatably coupled to the tire assembly; and
a gear box being rotatably coupled to the drive axle and mounted on the axle in such a position that it does not support weight of the tower.

2. A wheel assembly as claimed in claim 1, wherein the gear box is mounted outside the support frame.

3. A wheel assembly as claimed in claim 1, wherein the tire assembly includes dual wheels.

4. A wheel assembly as claimed in claim 1, wherein the tire assembly includes at least one wheel having a belt with traction elements.

5. A wheel assembly as claimed in claim 1, wherein the support frame provides for an adjustable connection between the tower and the tire assembly.

6. A wheel assembly as claimed in claim 5, wherein the adjustable connection between the tower and the tire assembly is provided by at least one slotted plate.

7. A wheel assembly as claimed in claim 5, wherein the adjustable connection between the tower and the tire assembly is provided by at least one spring.

8. A wheel assembly as claimed in claim 5, wherein the adjustable connection between the tower and tire assembly is provided by telescoping members.

9. A wheel assembly as claimed in claim 5, wherein the adjustable connection between the tower and tire assembly is provided by a pillow block bearing.

10. A wheel assembly as claimed in claim 1, wherein the wheel assembly includes a swivel support tube that is telescopically coupled to a tube of the tower, allowing the wheel assembly to swivel around the tower.

11. A wheel assembly as claimed in claim 1, further comprising a support frame having:
a first support member for supporting a tire assembly on one side;
a second support member for supporting the tire assembly on the opposite side and coupled to the first support member, such that the weight of the tower is distributed substantially equally across the opposite sides of the tire assembly.

12. A wheel assembly as claimed in claim 11, wherein the first support member is connected to the second support member, creating a support frame having a substantially U-shape.

13. A wheel assembly as claimed in claim 11, wherein the first support member is adjustably coupled to the second support member.

14. A wheel assembly as claimed in claim 1, further comprising a force transfer member coupled between the support member and the tower for transferring forces generated by the tire assembly to the tower.

15. A wheel assembly as claimed in claim 14, wherein the force transfer member provides for an adjustable connection to the tower.

16. A wheel assembly for a corner sweeping unit having an elongated boom and at least one downwardly extending tower connected to a wheel assembly, a wheel assembly comprising:
a support frame having a first support member for supporting a tire assembly on one side;
a second support member for supporting the tire assembly on the opposite side and adjustably coupled to the first support member, such that the weight of the tower is distributed substantially equally across the opposite sides of the tire assembly;
at least one drive axle rotatably coupled to the tire assembly; and
a gear box being rotatably coupled to the drive axle and mounted on the axle in such a position that it does not support weight of the tower.

17. A wheel assembly as claimed in claim 16, wherein the gear box is mounted outside of the support frame.

18. A wheel assembly as claimed in claim 17, wherein the support frame is adjustably mounted on the tire assembly.

19. A wheel assembly as claimed in claim 11, wherein the gear box is mounted outside of the support frame.
